(19) United States
(12) Patent Application Publication
(10) Pub. No.: US 2005/0122719 A1
(43) Pub. Date: Jun. 9, 2005

(54) Light signal

(75) Inventors: Jorg Liebscher, Wolfenbuttel (DE); Dirk Zimmermann, Berlin (DE)

Correspondence Address: MORRISON & FOERSTER LLP, 1650 TYSONS BOULEVARD, SUITE 300, MCLEAN, VA, 22102, US

(73) Assignee: Siemens AG, Munchen (DE)

(21) Appl. No.: 10/850,433

(22) Filed: May 21, 2004

(30) Foreign Application Priority Data
Dec. 5, 2003 (DE) 103 58 053.0

(51) Int. Cl. F21S 2/00

(52) U.S. Cl. 362/257

(57) ABSTRACT

A light signal with a luminous device and a first optical system for displaying signal indications on rail-bound traffic routes is provided. To allow different types of luminous devices to be used while retaining the first optical system, a second optical system is arranged between the luminous device and the first optical system. The focal point of the second optical system essentially coincides with a focal point of the first optical system on a light entry side.

### CLAIM FOR PRIORITY

This application claims priority to German Application No.

10358053.0 which was filed in the German language on Dec. 5, 2003.

### FIELD OF THE INVENTION

The invention relates to luminous signals and light signals for the display of signal indications on rail-bound traffic routes.

### BACKGROUND OF THE INVENTION

In the case of known light signals, an incandescent lamp is primarily used as the luminous device, the light of which is directed in a defined solid angle by an optical system. The optical system generally comprises Fresnel lenses or aspherical lenses, at the focal point of which, on the light entry side, the spiral-wound filament of the incandescent lamp is arranged. With the introduction of novel luminous devices, in particular based on LEDs (light-emitting diodes), there is an increasing need to replace incandescent lamps with more modern luminous devices. One of the main problems involved in doing this is optical adaptation, since the existing optical system is specifically designed for the special radiation characteristics of the incandescent lamp. Modern luminous devices have entirely different radiation characteristics, with the result that simple replacement of the incandescent lamp, for example by an LED arrangement, entails losses of light in the solid angle that is relevant for the display of the signal indication. In order to ensure equivalent optical properties of the light signal, it is therefore generally necessary for the complete optical system to be replaced by an optical system specific for the new luminous device.

### SUMMARY OF THE INVENTION

An object of the invention is to provide a generic light signal which makes it possible for the existing optical system to continue to be used as a luminous device of various types.

According to an aspect of the invention, a light signal has a luminous device and a first optical system for displaying signal indications on rail-bound traffic routes. Between the luminous device and the first optical system, there is arranged a second optical system, the focal point of which essentially coincides with the focal point of the first optical system on the light entry side. The interposing of a second optical system, which produces an image of the luminous device at the focal point of the existing optical system on the light entry side, provides the possibility of continuing to use the signal housing together with the focusing optics without any losses in quality with regard to the solid angle that is to be illuminated. It is merely necessary to focus a large part of the amount of light radiated by the new luminous device onto a focal point which coincides with the focal point of the first optical system. The second optical system may be a simple converging lens or a Fresnel plate, which do not have to meet any special quality requirements. The high-quality first optical system provides optimum illumination of the solid angle that is decisive for the visibility of the signal indication, in particular by the operating personnel of the rail-bound means of transport.

It is particularly advantageous that the first optical system can continue to be used if is suitable for the long-range and short-range display of signal indications, i.e. if special optics are present, for example at the lower edge of the first optical system, for downward light diffusion, i.e. in the direction of the ground.

According to another aspect of the invention, the new luminous device can be an LED arrangement. Luminous signals or light signals that have previously been provided with incandescent lamps are often to be converted on the basis of LEDs, since LEDs are comparatively inexpensive, long-lasting and have a high luminous intensity. Known LED light signals essentially include a grid-like arrangement of a number of LEDs, which are respectively provided with a reflector, a light-focusing optical element and possibly a front plate. The optical element must, in this case, be as suitable as possible for different points of attachment and observation, curve radii of the rail route and identification distances. To make it possible to dispense with the development and installation of such optical elements, the invention merely provides an optical adaptation to the tried-and-tested system for spiral-wound filament luminous devices. This second optical system, serving for the adaptation, may be of a comparatively simple construction, since it is merely necessary to focus the light at a focal point and it is not required to take the short and long range, curve radii and other parameters into account.

The LED arrangement according to another aspect of the invention may be a single LED with a focusing lens, which forms the second optical system.

According to another aspect of the invention, an LED matrix may also be fitted with a number of LED modules for forming a prescribed radiating area. Each module preferably contains a specific number of individual LEDs, which are wired in such a way that a safety concept with respect to LED failure can be realized. Furthermore, each LED module may be provided with an optical element of its own. The entirety of the optical elements of all the LED modules of the LED matrix then form the second optical system according to this aspect of the invention. The LED modules together with the optical elements are preferably accommodated in a housing, which is fitted in a sealed manner in a matrix plate in the vicinity of the light-exiting area. The LEDs may be arranged, for example, in groups corresponding to the modules on a printed circuit board and together supplied with current. Further structural design measures may be provided to take into account the operating parameters of the LEDs, for example, with regard to temperature control. An optimum in terms of light output, utilization and service life is obtained with an operating state somewhat below the recommended values. By contrast with the incandescent lamp—the relative light yield, i.e. the brightness per unit of power used, also improves under such conditions.

Further according to this aspect of the invention, sheet-like luminous elements, for example based on organic LEDs, may also be provided as modern luminous devices that come into consideration for the replacement of incandescent lamps. As for any other conceivable luminous device, for example, based on light guides—continued use of the main optics is also made possible for these luminous devices by the use of light focusing optics which do not have to have any imaging quality.

### BRIEF DESCRIPTION OF THE DRAWINGS

The invention is explained in more detail below on the basis of representations in the form of figures, in which:

FIG. 1 shows the basic construction of a conventional incandescent lamp signal, and

FIG. 2 shows a signal setup with an LED matrix.

### DETAILED DESCRIPTION OF THE PREFERRED EMBODIMENTS

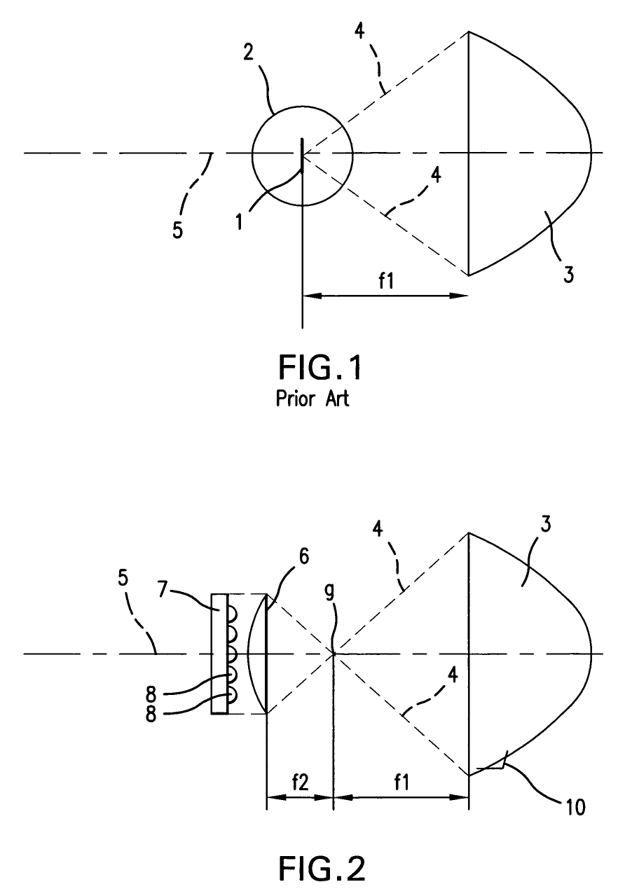

In FIG. 1, the functional principle of an incandescent lamp signal according to the prior art is illustrated. The spiral-wound filament 1 of an incandescent lamp 2 is, in this case, arranged at the focal point of an optical system 3 of the focal length f1. Characteristic of the spiral-wound filament 1 is a radiation cone 4, the beam angle of which determines the diameter and the optical axis 5 of the optical system 3. The optical system 3 is in this case usually designed for a Fresnel and/or aspherical lens form in such a way that a high light intensity for the long range and for the angled-down short range is obtained, with site-specific parameters, such as, for example, the track radius at the installation site, being taken into account.

To allow this high-quality optical system also to be used for other luminous devices instead of the spiral-wound filament 1, a second optical system 6 is provided in the form of a focusing lens, as can be seen from FIG. 2. The light of an LED matrix 7, which is fitted with a number of LEDs 8, is focused by this second optical system 6 of the focal length f2 onto a focal point 9 which coincides with the focal point of the first optical system 3, and consequently with the position of the spiral-wound filament in FIG. 1. In this way, the supplementary second optical system 6 produces at the focal point 9 a kind of filament-like light spot, which is diffused by the taken-over first optical system 3 into the desired long range and by an indicated lens segments 10 into the short range.

The invention is not restricted to the exemplary embodiment specified above. Rather, there are a number of conceivable variants which also make use of the features of the invention in a configuration that is fundamentally different.

1. A light signal with a luminous device and a first optical system for displaying signal indications on rail-bound traffic routes, comprising:
a second optical system arranged between the luminous device and the first optical system, where a focal point of the second optical system essentially coincides with a focal point of the first optical system on a light entry side.

2. The light signal as claimed in claim 1, wherein the luminous device is formed as an LED arrangement.

3. The light signal as claimed in claim 2, wherein the LED arrangement comprises a single LED which has a focusing lens as the second optical system.

4. The light signal as claimed in claim 2, wherein the LED arrangement is formed as an LED matrix with a plurality of essentially identical LED modules, which define an essentially circular radiation area.

5. The light signal as claimed in claim 1, wherein the luminous device is formed as an essentially circular luminous area and is based on organic LEDs.
